(19) United States
(12) Patent Application Publication
(10) Pub. No.: US 2010/0015287 A1
(43) Pub. Date: Jan. 21, 2010

(54) ORGANIC ANTIOXIDANT WATER BEVERAGE

(76) Inventors: Maziar Ghodsian, Newport Beach, CA (US); Andree Armand, Venice, CA (US)

Correspondence Address: PATENT INGENUITY, PC, 520 BROADWAY, SUITE 350, SANTA MONICA, CA, 90401, US

(21) Appl. No.: 12/338,967

(22) Filed: Dec. 18, 2008

Related U.S. Application Data
(63) Continuation-in-part of application No. 12/177,081, filed on Jul. 21, 2008.

(51) Int. Cl. A23L 2/58; A23L 2/38; A23L 2/46

(52) U.S. Cl. 426/66

(57) ABSTRACT

A process is provided. The process composes a solution that includes water and organic maltodextrin such that the organic maltodextrin is soluble in the water. Further, the process adds an organic compliant color to the solution such, and at least seventy percent of a dry weight of the solution is organic substances. The organic compliant color includes at least one antioxidant. The organic compliant color includes at least one antioxidant. Finally, the process heat treats the solution.

### RELATED APPLICATIONS

This application is a Continuation-In-Part application of U.S. patent application Ser. No. 12/177,081, filed on Jul. 21, 2008 and entitled WATER BEVERAGE, which is hereby incorporated by reference in its entirety.

### BACKGROUND

1. Field

This disclosure generally relates to the field of beverages. More particularly, the disclosure relates to a hydration beverage.

2. General Background

A number of hydration beverage products are currently in the marketplace. Drinking waters are an example of such hydration beverage products. Drinking waters may include mineral water, spring water, reverse osmosis water, deionized water, vapor distilled water, purified water, and carbonated water. Electrolyte enhanced drinking water is another example. Electrolyte enhanced drinking water is typically a combination of at least one salt, e.g., calcium, potassium, or magnesium, and at least one water source such as vapor distilled water, reverse osmosis water, purified water, ultra pure, or the like. Vitamin enhanced waters are yet another example. Vitamin enhanced waters typically include a variety of vitamins and minerals, flavors (natural, artificial or organic flavors), colors, and/or sweeteners. A preservative may also be utilized in the vitamin enhanced waters. Flavor enhanced waters are yet another example. Flavor enhanced waters typically include water (carbonated or still) and a flavor (natural, artificial, or organic). The flavored water may or may not include a natural, artificial, or organic color or sweetener. Sports drinks are yet another example. Sports drinks typically include electrolytes, a flavor (natural, artificial, or organic), a sweetener (natural, artificial, or organic), a color (natural, artificial, or organic), and a preservative. The electrolytes may be derived from sodium, potassium, or chloride salts. Various other beverages are also currently being marketed. Carbonated sodas, fruit juices, drinks with fruit juices, energy drinks, and a variety of other beverages also have water.

Further, some beverage products include antioxidants to help improve the health and potentially prevent diseases in individuals. For example, antioxidant enhanced waters are beverage products that typically include an antioxidant, a flavor (natural, organic or artificial flavor), and/or color (natural, artificial, or organic), and/or a sweetener (natural, artificial, or organic). An antioxidant is a molecule that helps minimize or prevent oxidation of other molecules, which may damage cells. Examples of synthetic antioxidants include vitamin C and vitamin E. Antioxidants in beverage products are typically synthetically derived from vitamins such as vitamin C or vitamin E. A preservative may also be utilized.

The antioxidant water beverage products currently on the market contain a synthetic antioxidant and a chemical preservative. By being synthetic, the antioxidant in these water beverage products is formulated or manufactured from a process, other than a naturally occurring biological process, that chemically changes a substance derived from a naturally occurring plant, animal, or mineral source. Further, the chemical preservative is typically utilized to preserve the beverage product's flavors, carbohydrates, and other ingredients to extend its shelf life. The chemical preservative also inhibits microbiological growth of potential microorganisms. Heat treatment may be utilized alternatively or in conjunction with the chemical preservative to inhibit or reduce potential microbial growth.

In addition, consumers typically indicate that the best beverage for hydration and thirst quenching is water. Water is essential to life, and proper hydration is necessary for maintaining proper physiologic homeostasis in the human body. However, most people, including, but not limited to, children do not drink the recommended daily amount of water.

Many of the hydration beverage products that are currently marketed have added flavors that mask the taste of water. As a result, consumers may not feel that many of these beverage products provide sufficient hydration or quench their thirst.

### SUMMARY

In one aspect of the disclosure, a process is provided. The process composes a solution that includes water and organic maltodextrin such that the organic maltodextrin is soluble in the water. Further, the process adds an organic compliant color to the solution, and at least seventy percent of a dry weight of the solution is organic substances. The organic compliant color includes at least one antioxidant. Finally, the process heat treats the solution.

In another aspect, a process is provided. The process composes a solution that includes water and organic maltodextrin such that the organic maltodextrin is soluble in the water. Further, the process adds an organic color to the solution. The organic color includes at least one antioxidant. Finally, the process heat treats the solution.

In yet another aspect, a process is provided. The process composes a solution that includes water and at least one organic carbohydrate such that the organic carbohydrate is soluble in the water. Further, the process adds an organic compliant color to the solution such that at least seventy percent of a dry weight of the solution is organic substances. Finally, the process heat treats the solution.

In another aspect, a process is provided. The process composes a solution that includes water and at least one organic carbohydrate such that the organic carbohydrate is soluble in the water. Further, the process adds an organic color to the solution. Finally, the process heat treats the solution.

In yet another aspect, a process is provided. The process composes a solution that includes water and at least one organic carbohydrate such that the organic carbohydrate is soluble in the water. Further, the process heat treats the solution.

### BRIEF DESCRIPTION OF THE DRAWINGS

The above-mentioned features of the present disclosure will become more apparent with reference to the following description taken in conjunction with the accompanying drawings wherein like reference numerals denote like elements and in which:

FIG. 1 illustrates a process that may be utilized to provide a water beverage.

FIG. 2 illustrates another process that may be utilized to provide an organic antioxidant water beverage.

FIG. 3 illustrates yet another process that may be utilized to provide an organic antioxidant water beverage.

FIG. 4 illustrates another process that may be utilized to provide an organic antioxidant water beverage.

FIG. 5 illustrates another process that may be utilized to provide an organic antioxidant water beverage.

### DETAILED DESCRIPTION

A process that produces a water beverage is provided. In one embodiment, a color is added to a solution to provide a water beverage that makes the water more appealing to consumers. As a result, more consumers may come closer to meeting the recommended daily amounts of water intake. Further, in one embodiment, the water beverage does not have preservatives. In another embodiment, the water beverage may include one or more antioxidants to help improve the health of the consumer. In yet another embodiment, a flavor is imparted into the beverage naturally as a result of the flavor of the color provided without flavor extract enhancement to the water beverage. In another embodiment, the process utilizes one or more organic carbohydrates with or without one or more organic acidifying agents or one or more organic juice concentrates and a color that is an antioxidant in a composition that is heat treated. The organic carbohydrate and organic acidifying agent or one or more organic juice concentrates may be at least seventy organic. In another embodiment, the process utilizes one or more organic acidifying agents with a color that may be an antioxidant in a composition that is heat treated. As a result, the composition may be given an organic designation through the appropriate regulatory organizations.

Examples of an acidifying agent include, but are not limited to, citric acid, tartaric acid, acetic acid, malic acid, phosphoric acid, etc. In one embodiment, the pH of the acidifying agent is less than four and six tenths.

Antioxidants may be naturally contained in colors, flavors, juices and concentrates such as in organic grape concentrate or organic purple carrot juice. Acidifying agents may also be utilized to inhibit or reduce the potential growth of microorganisms.

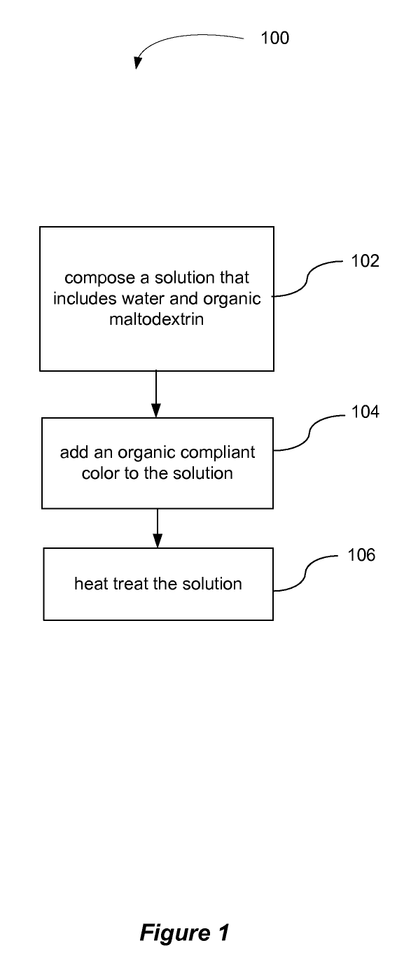

FIG. 1 illustrates a process 100 that may be utilized to provide an organic antioxidant water beverage. At a process block 102, the process 100 composes a solution that includes water and organic maltodextrin such that the organic maltodextrin is soluble in the water. The water may be a variety of different types of water. For example, the water may be a municipal water source, spring water, mineral water, carbonated water, artesian water, purified water or any type of drinking water. Purified water is water that is physically processed to remove impurities. Purified water processes may include carbon filtration, microporous filtration, ultrafiltration, ultraviolet oxidation, reverse osmosis, distillation, vapor distillation, electrodialysis, or any other type of water purification process. Reverse osmosis water is obtained by a filtration process that produces purified water by utilizing a pressurized membrane system. Vapor distilled water is distilled water that has had its impurities removed through distillation, which is boiling of water and condensing the steam into a clean container. Deionized water is purified water that uses ion exchange that binds to and filters out mineral salts from water. Further, the term organic is intended herein to refer to substances produced without conventional pesticides, artificial fertilizers, human waste, or sewage sludge and processed without ionizing radiation. Accordingly, any organic substance used in this invention is produced and processed as an organic substance.

Further, at a process block 104, the process 100 adds an organic compliant color to the solution such that at least seventy percent of a dry weight of the solution is organic substances. The organic compliant color includes at least one antioxidant. The term organic compliant is intended herein to refer to a substance that is not organic, but that may be utilized with organic substances without necessarily not qualifying for the organic designation from the overall product. For example, an organic compliant color may exclude certain synthetic, nonsynthetic, nonagricultural, and nonorganic agricultural substances, but may not be organic itself. In one embodiment, at least seventy percent of the dry weight of the resulting solution, i.e., the weight without the water, is organic substances. In one embodiment, the dry weight is the weight without water and salt. As a result, the resulting solution may be considered organic. For example, a solution with a dry weight of which at least seventy percent is organic maltodextrin and five percent is natural color may be designated with an organic designation. In addition, eight fluid ounces of the solution are less than or equal to one hundred calories in of the solution. For example, the organic water beverage may have zero calories.

In addition, at a process block 106, the process heat treats the solution at a predetermined temperature performed for a predetermined time period. For example, the predetermined time period may be sixty seconds, and the predetermined temperature may be three hundred degrees Fahrenheit. Further, at a process block 104, the process 100 heat treats the solution. An example of heat treatment includes, but is not limited to, pasteurization, flash pasteurization, flash heating process, ultra heat treatment or ultra high temperature treatment, high temperature short time treatment and extended shelf life treatment. As an alternative to the heat treatment, other preservation processing methods such as aseptic processing may also be utilized. As yet another alternative to the heat treatment, ozonation and or ultraviolet treatment may be utilized. The type of treatment that is selected may depend on the type of packaging that is utilized.

In another embodiment, the process 100 fills the solution, after the heat treatment, at a predetermined temperature into a container that can withstand the temperature of the particular type of packaging that is utilized. For example, a polyethylene terephthalate plastic container may be filled at a temperature of at least one hundred sixty five degrees Fahrenheit. The container may be composed from plastics such as polyethylene terephthalate plastics, glass, or other container types. The container may alternatively be composed of a combination of such materials.

In yet another embodiment, the process 100 seals the container with a cap inverted for a maximum time period of fifteen minutes to inhibit the growth of any potential microorganisms in the cap. Further, the process 100 may cool the container, through a water bath. Other types of cooling mechanisms may be utilized.

The organic compliant color may be a liquid, syrup, semi-solid, solid, or powder form. The organic compliant color is soluble in water. The organic compliant color may be either natural or at least seventy percent organic. At least one antioxidant in the organic compliant color may contain vitamins and minerals.

In one embodiment, alternatives may be utilized for the organic maltodextrin. For example, rice dextrin or tapioca flour/starch, corn, sorghum or other organic carbohydrates or grains in liquid, syrup, semi-solid, powder, or solid form that is at least seventy percent organic may be utilized. Alternatively, any other substances from dextrin derivatives may be utilized. Dextrins are a group of low molecular weight carbohydrates produced by the hydrolysis of starch.

An organic carbohydrate is a food additive that may act as a binding agent, carrier, water soluble glue, or thickening agent. Alternatively other types of organic carbohydrates may be utilized. The organic carbohydrate is at least seventy percent organic. Further, the organic carbohydrate may have levels of dextrose content ranging from one to sixty dextrose equivalents or may contain less than one percent to ninety nine percent organic carbohydrates. In addition, the organic carbohydrate is soluble in water.

In one embodiment, the organic carbohydrate is a fiber source. In yet another embodiment, the process 100 may add a fiber source to the solution. The fiber source may be a liquid, syrup, semi-solid, solid, or powder form. In one embodiment, the fiber source is soluble in water. The fiber source may be organic compliant, or at least seventy percent organic. In one embodiment, the fiber source may have levels of fiber ranging from less than one percent to one hundred percent. In one embodiment, the fiber source is added to the solution when the organic carbohydrate is not a fiber source. In another embodiment, the fiber source is added to the solution as an additional fiber source when the organic carbohydrate is a fiber source.

In one embodiment, the process 100 may add at least one electrolyte to the solution. The electrolyte may be a liquid, syrup, semi-solid, solid, or powder form. The electrolyte may be from any class including Sodium, Potassium, Chloride, Magnesium, Phosphorus, Manganese, Zinc, Boron, Calcium, Copper, Fluoride, Iodine, Iron, Molybdenum, Nickel, Selenium, etc. In one embodiment, the electrolyte is soluble in water. In another embodiment, the electrolyte is organic compliant. In another embodiment, the electrolyte is at least seventy percent organic.

In another embodiment, the process 100 may add a stimulant to the solution. The stimulant may be a liquid, syrup, semi-solid, solid, or powder form. The stimulant may be caffeine, guarana, yerba mate, or other natural stimulants. In one embodiment, the stimulant is organic compliant. In another embodiment, the stimulant is at least seventy percent organic.

In yet another embodiment, the solution is maintained at a predetermined pH level to prevent microbiological spoilage or growth of the organic antioxidant water beverage. In one embodiment, the organic compliant color has a pH in the range of two and nine. In another embodiment, the process 100 acidifies the organic compliant color so that the organic compliant color has a pH in the range of three and one half and four and sixth tenths. In yet another embodiment, the process 100 acidifies the solution with an acidifying agent so that the solution has a pH that is less than four and sixth tenths. In one embodiment, an optimal pH for the organic antioxidant water beverage is four and two tenths. Examples of an acidifying agent include, but are not limited to, citric acid, tartaric acid, acetic acid, malic acid, phosphoric acid, etc.

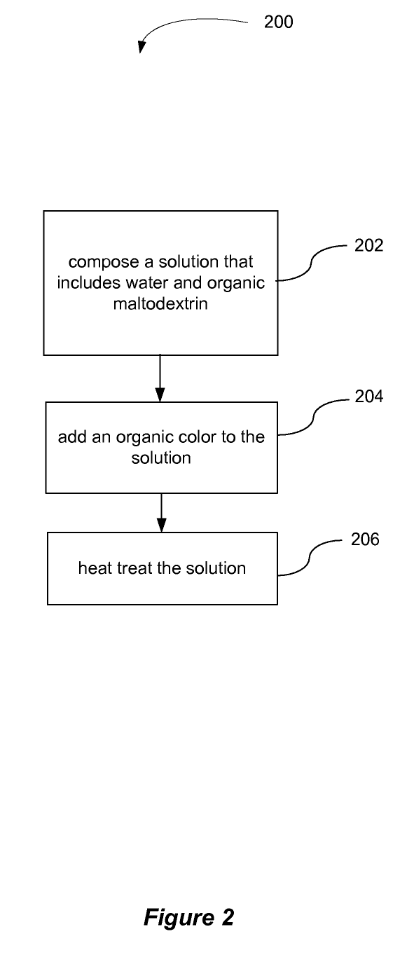

FIG. 2 illustrates another process 200 that may be utilized to provide an organic antioxidant water beverage. At a process block 202, the process 200 composes a solution that includes water and organic maltodextrin such that the organic maltodextrin is soluble in the water. Further, at a process block 204, the process 200 adds an organic color to the solution. The organic color includes at least one antioxidant. In addition, at a process block 206, the process 200 heat treats the solution.

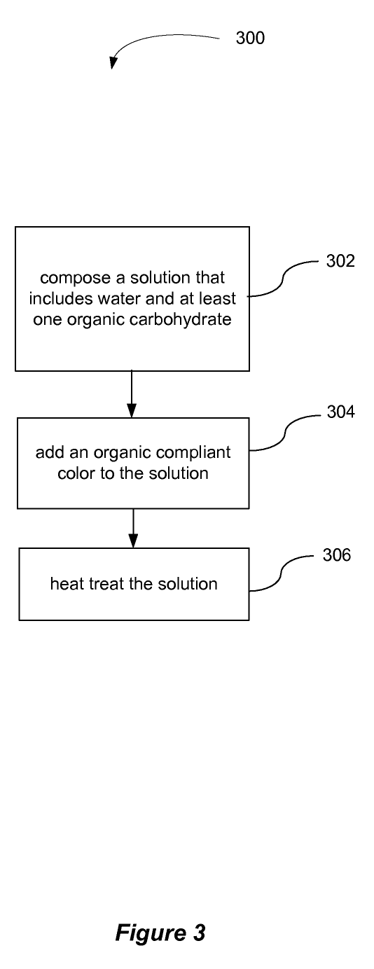

FIG. 3 illustrates yet another process 300 that may be utilized to provide an organic antioxidant water beverage. At a process block 302, the process 300 composes a solution that includes water and at least one organic carbohydrate such that the organic carbohydrate is soluble in the water. Further, at a process block 304, the process 300 adds an organic compliant color to the solution such that at least seventy percent of a dry weight of the solution is organic substances. In addition, at a process block 306, the process 300 heat treats the solution.

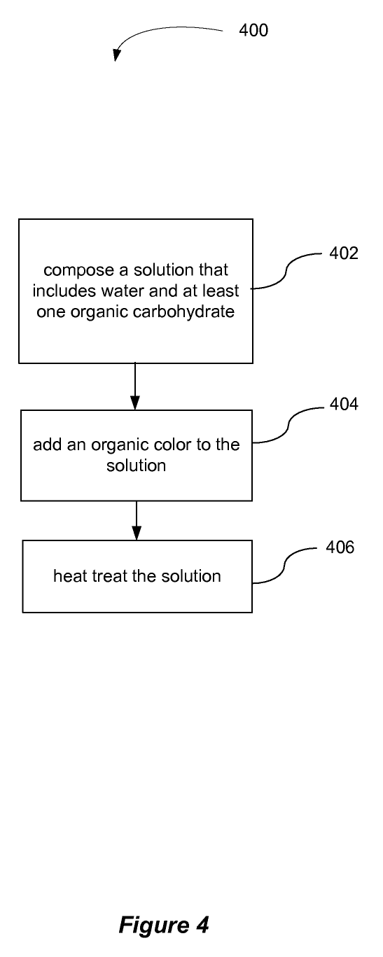

FIG. 4 illustrates another process 400 that may be utilized to provide an organic antioxidant water beverage. At a process block 402, the process 400 composes a solution that includes water and at least one organic carbohydrate such that the at least one organic carbohydrate is soluble in the water. In addition, at a process block 404, the process 400 adds an organic color to the solution. Finally, at a process block 406, the process 400 heat treats the solution.

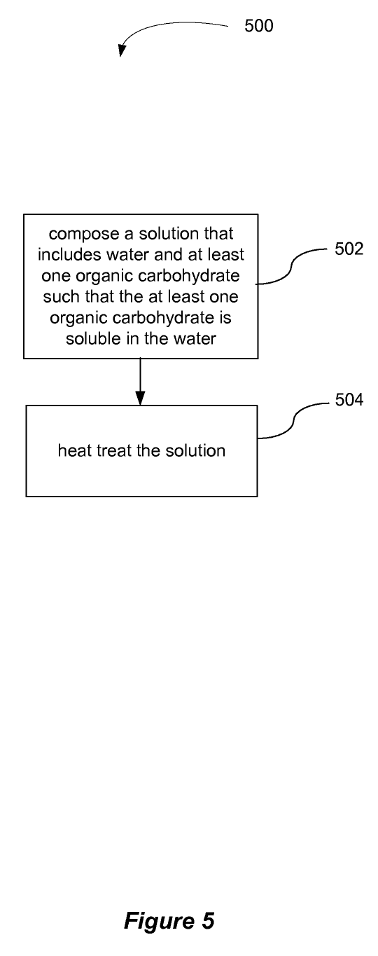

FIG. 5 illustrates another process 500 that may be utilized to provide an organic antioxidant water beverage. At a process block 502, the process 500 composes a solution that includes water and at least one organic carbohydrate such that the at least one organic carbohydrate is soluble in the water. Further, at a process block 504, the process 500 heat treats the solution. In another embodiment, the various calorie restrictions described in the other configurations herein may also be utilized with the process 500. An example of the organic carbohydrate is organic maltodextrin. Alternatively, any other substances from the dextrins may be utilized. In one embodiment, the at least one organic carbohydrate may be a substance that is at least seventy percent organic may be utilized. Alternatively, any other substances from the dextrins may be utilized.

In another embodiment, a process is provided. The process composes a solution that includes water and one or more organic juice concentrates that contains one or more organic acidifying agent such that the solution is soluble in water. In one embodiment, the organic acidifying agent is an antioxidant. The organic juice concentrate is at least seventy percent organic. The organic juice concentrate may contain less than one percent to one hundred percent of the active acidifying agent. For example, organic grape concentrate may contain less than one percent to one hundred percent of tartaric acid. Further, the process heat treats the solution.

In another embodiment, a process is provided. The process composes a solution that includes water and one or more organic acidifying agents such that the solution is soluble in water. The organic acidifying agent is at least seventy percent organic. The organic acidifying agent may contain less than one percent to one hundred percent of the active acidifying agent. For example, organic tartaric acid may contain less than one percent to one hundred percent of tartaric acid. Further, the process heat treats the solution.

In yet another embodiment, a process is provided. The process composes a solution that includes water, one or more organic carbohydrates and one or more organic juice concentrates that contains one or more organic acidifying agents such that the solution is soluble in water. The organic juice concentrate may contain less than one percent to one hundred percent of the active acidifying agent. For example, organic grape concentrate may contain less than one percent to one hundred percent of tartaric acid. The organic carbohydrate may contain less than one percent to one hundred percent of the carbohydrate. For example, the organic carbohydrate may contain less than one percent to one hundred percent of organic maltodextrin. Both the organic carbohydrate and the organic juice concentrate are at least seventy percent organic. Further, the process heat treats the solution.

In another embodiment, a process is provided. The process composes a solution that includes water, one or more organic carbohydrates and one or more organic acidifying agents so that the solution is soluble in water. The organic acidifying agent may contain less than one percent to one hundred percent of the active acidifying agent. For example, organic tartaric acid may contain less than one percent to one hundred percent of tartaric acid. The organic carbohydrate may contain less than one percent to one hundred percent of the carbohydrate. For example, the organic carbohydrate may contain less than one percent to one hundred percent of organic maltodextrin. Both the organic acidifying agent and the organic juice concentrate are at least seventy percent organic. Further, the process heat treats the solution.

Any of the processes described herein may alternatively compose a solution that includes water and one or more organic acidifying agents instead of one or more organic carbohydrates and an acidifying agent. In other words, a single organic acidifying agent may be utilized. In any of the process described herein, the organic acidifying agent may be an antioxidant. In one embodiment, a single organic acidifying agent may be utilized instead of at least one organic carbohydrate and at least one acidifying agent.

Any of the variations described herein may be applicable to any of the processes also described herein. For example, the various heat treatment techniques may be applicable to any of the processes described herein.

It is understood that the process described herein may also be applied with other configurations. Those skilled in the art will appreciate that the various adaptations and modifications of the embodiments of this process may be configured without departing from the scope and spirit of the present process. Therefore, it is to be understood that, within the scope of the appended claims, the present process may be practiced other than as specifically described herein.

We claim:

1. A method comprising:
composing a solution that includes water and organic maltodextrin such that the organic maltodextrin is soluble in the water;
adding an organic compliant color to the solution such that at least seventy percent of a dry weight of the solution is organic substances, the organic compliant color including at least one antioxidant; and
heat treating the solution.

2. The method of claim 1, wherein the heat treating of the solution is performed for a predetermined temperature for a predetermined time.

3. The method of claim 1, further comprising filling the solution, after the heat treating, at a predetermined temperature into a container that can withstand the temperature of the particular type of packaging that is utilized.

4. The method of claim 3, wherein container is composed of a polyethylene terephthalate plastic.

5. The method of claim 1, further comprising sealing the container with a cap inverted for a maximum time period of fifteen minutes to inhibit potential microbiological growth in the cap.

6. The method of claim 5, further comprising cooling the container, through a water bath.

7. The method of claim 1, wherein the water is reverse osmosis water.

8. The method of claim 1, wherein the water is purified water.

9. The method of claim 1, wherein the organic compliant color has a pH in the range of two to nine.

10. The method of claim 1, further comprising acidifying the organic compliant color so that the solution with the organic compliant color has a pH less than four and six tenths.

11. The method of claim 1, further comprising acidifying the solution so that the solution has a pH less than four and six tenths.

12. The method of claim 1, further comprising adding a stimulant to the solution.

13. A method comprising:
composing a solution that includes water and organic maltodextrin such that the organic maltodextrin is soluble in the water;
adding an organic color to the solution, the organic color including at least one antioxidant; and
heat treating the solution.

14. The method of claim 13, wherein the heat treating the solution is performed for a predetermined time period at a predetermined temperature.

15. The method of claim 13, further comprising filing the solution, after the heat treating, at a predetermined temperature into a container that can withstand a predetermined temperature into a container that can withstand the temperature of a particular type of packaging that is utilized.

16. A method comprising:
composing a solution that includes water and at least one organic carbohydrate such that the organic carbohydrate is soluble in the water;
adding an organic compliant color to the solution such that at least seventy percent of a dry weight of the solution is organic substances; and
heat treating the solution.

17. The method of claim 16, wherein the organic compliant color includes at least one antioxidant.

18. The method of claim 16, wherein the organic carbohydrate is maltodextrin.

19. The method of claim 16, wherein the organic carbohydrate is an organic fiber source.

20. A method comprising:
composing a solution that includes water and at least one organic carbohydrate such that the at least one organic carbohydrate is soluble in the water;
adding an organic color to the solution; and
heat treating the solution.

21. The method of claim 20, wherein the organic color includes at least one antioxidant.

22. The method of claim 20, wherein the organic carbohydrate is maltodextrin.

23. The method of claim 20, wherein the organic carbohydrate is an organic fiber source.

24. A method comprising:
composing a solution that includes water and at least one organic carbohydrate such that the at least one organic carbohydrate is soluble in the water; and
heat treating the solution.
